(19) United States
(12) Patent Application Publication
(10) Pub. No.: US 2023/0377402 A1
(43) Pub. Date: Nov. 23, 2023

(54) COIN STACKING DEVICE

(71) Applicant: INTERNATIONAL GAMES SYSTEM CO., LTD., New Taipei City (TW)

(72) Inventors: Chunying XU, GUANGZHOU (CN); Polun LIN, New Taipei City (TW)

(21) Appl. No.: 18/186,216

(22) Filed: Mar. 20, 2023

(30) Foreign Application Priority Data
May 17, 2022 (CN) 202210536949.8

(51) Int. Cl. G07D 9/06; G07D 9/00

(52) U.S. Cl. CPC G07D 9/06; G07D 9/008

(57) ABSTRACT

A coin stacking device includes a main frame, a coin feeding module, a coin storage portion, a movable stage, a coin organizing device, an elevating device and a rotating device. The coin storage portion is connected to the main frame. The movable stage is movably disposed within the coin storage portion. The coin organizing device is located on the main frame and used to synchronously concentrate coins from the coin feeding module onto the movable stage in a radiation manner, and to organize the coins onto the movable stage in a ring shape. The elevating device is elevatably located on the main frame for elevating the movable stage. The rotating device is connected to the elevating device for rotating the movable stage. The coins are able to be stacked successively into a coin tower by the coin organizing device, the elevating device and the rotating device.

### RELATED APPLICATIONS

This application claims priority to China Application Serial Number 202210536949.8, filed on May 17, 2022, which is herein incorporated by reference.

### BACKGROUND

### Field of Disclosure

The present disclosure relates to a coin stacking device. More particularly, the present disclosure relates to a coin stacking device for a coin game machine.

### Description of Related Art

As well known, a coin-stacking game machine is operated to gradually stack coins into a coin tower on a push area in the coin-stacking game machine, and then to knock down the coin tower on the push area in the game machine. More specifically, a coin stacking method of the conventional game machine is to interpose one coin from the bottom of the coin tower one another to build a higher tower.

However, when a user wins the game, the stacking time that the user waits for stacking a coin tower at the game machine is quite long, so improvement for the game machine is still required.

It is noted that the above-mentioned technology obviously still has inconvenience and defects, and needs to be further improved. Therefore, how to develop a solution to improve the foregoing deficiencies and inconvenience is an important issue that relevant persons engaged in the industry are currently unable to delay.

### SUMMARY

One aspect of the present disclosure is to provide a coin stacking device to solve the aforementioned problems of the prior art.

In one embodiment of the present disclosure, a coin stacking device is provided, and the coin stacking device includes a main frame, a coin feeding module, a coin storage portion, a movable stage, a coin organizing device, an elevating device and a rotating device. The main frame is formed with an opening. The coin feeding module is used to feed a plurality of coins. The coin storage portion is connected to the opening, and provided with an axial channel that is in communication with the opening. The movable stage is movably disposed within the axial channel. The coin organizing device is located on the main frame to surround the opening, and configured to synchronously concentrate the coins from the coin feeding module onto the movable stage in a radiation manner through the opening, and organize the coins on the movable stage in a ring shape. The elevating device is connected to the movable stage, and elevatably located on the main frame for elevating the movable stage. The rotating device is connected to the elevating device for rotating the movable stage. The coins are able to be stacked successively into a coin tower having a plurality of coin-stacking layers through repeated operations of the coin organizing device, the elevating device and the rotating device.

In one or more embodiments of the present disclosure, the coin organizing device further includes a stationary plate and a rotatable member. The stationary plate is fixedly mounted on the main frame, and formed with a first annular hole overlapping with the opening. The rotatable member includes an annular frame, a coin template sandwiched between the stationary plate and the annular frame, and fixedly connected to the annular frame, and a second annular hole located on the annular frame, and collectively forming a coin collecting recess with the coin template for receiving the coins. The coin template is formed with a plurality of coin holes located within the coin collecting recess and surrounding the first annular hole. A hole diameter of each of the coin holes is merely to accommodate one of the coins, and the coins are guided to directly fall onto the stationary plate by the coin holes so as to jointly surround the first annular hole.

In one or more embodiments of the present disclosure, the coin organizing device further includes a blade layer. The blade layer includes a plurality of blade pieces that are independent to one another. The blade pieces are respectively slidably located between the coin template and the stationary plate, and arranged side by side in sequence to enclose a changeable space that is connected to the axial channel through the first annular hole. The annular frame is able to move the blade pieces synchronously towards the first annular hole through the coin template, such that the blade pieces narrow the changeable space together. When the coin template moves the blade pieces synchronously to narrow the changeable space together, the blade pieces push the coins on the stationary plate from the first annular hole into the axial channel synchronously.

In one or more embodiments of the present disclosure, the rotatable member further includes an arc-shaped rack fixedly located at an outer peripheral surface of the annular frame being opposite to the second annular hole. The coin organizing device includes a first motor device having a rotating shaft, and a first gear member coaxially connected to the rotating shaft of the first motor device to be engaged with the arc-shaped rack. When the first motor device rotates the annular frame through the first gear member, the annular frame synchronously slides the blade pieces through the coin template.

In one or more embodiments of the present disclosure, the coin stacking device further includes a plurality of first sensing units and a processing unit. The first sensing units are arranged on the stationary plate. Each of the first sensing units is directed towards one of the coin holes, and is used to sense whether the one of the coin holes is placed with one of the coins. The processing unit is electrically connected to the first sensing units and the first motor device. The first sensing units respectively determine that the coins are placed into all of the coin holes, respectively, the processing unit instructs the first motor device to operate according to notifications of the first sensing units.

In one or more embodiments of the present disclosure, the coin stacking device further includes a coin stirring module. The coin stirring module includes a rotating ring, a plurality of stirring vanes and a second motor device. The rotating ring is rotatably located on the coin organizing device. The stirring vanes are spaced arranged on the rotating ring, respectively extend into the coin collecting recess, and contact the coin template for sweeping the coins in the coin collecting recess to the coin holes. The second motor device is fixedly mounted on the main frame for driving the rotating ring and the stirring vanes to rotate.

In one or more embodiments of the present disclosure, the coin feeding module includes a coin feeding track, a coin-feeding sensing unit and a third motor device. The coin feeding track is fixedly mounted on the main frame for guiding the coins into the coin collecting recess sequentially. The coin-feeding sensing unit is located on the coin feeding track for counting the coins already moved from the coin feeding track into the coin collecting recess. The third motor device is connected to the main frame so as to output vibrations for sending the coins into the coin feed track.

In one or more embodiments of the present disclosure, the elevating device includes at least one screw rod, at least one moving spiral tube, a bracket, a rotation-angle sensing unit, a fourth motor device, a gear wheel and a transmission belt. The screw rod is disposed on the main frame, and formed with an external thread portion. The moving spiral tube is elevatably sleeved on the screw rod, and formed with an internal thread portion which is engaged with the external thread portion. The bracket is fixedly connected to the moving spiral tube for loading the movable stage. The rotation-angle sensing unit is coupled to one end of the screw rod for sensing a rotation angle of the screw rod. The fourth motor device is fixedly mounted on the main frame, and provided with a rotating shaft. The gear wheel is coaxially connected to the rotating shaft of the fourth motor device. The transmission belt is engaged with the gear wheel and the at least one screw rod. When the fourth motor device drives the at least one screw rod to rotate in sequence, the at least one moving spiral tube moves the bracket and the movable stage to be relatively elevated in the axial channel.

In one or more embodiments of the present disclosure, the movable stage includes a cylinder and a rack portion. The cylinder is disposed on the bracket of the elevating device for loading the coins. The rack portion is fixedly mounted on an outer peripheral surface of the cylinder. The rotating device includes a fifth motor device and a gear assembly. The fifth motor device is fixedly mounted on the bracket of the elevating device. The gear assembly is coaxially connected to a rotating shaft of the fifth motor device, and engaged with the rack portion for rotating the cylinder. When the fifth motor device drives the cylinder to rotate, the coins are rotated with the cylinder in the axial channel together.

In one or more embodiments of the present disclosure, the coin stacking device further includes two second sensing units and a processing unit. The second sensing units are located relatively in the opening for sensing whether the coins are pushed into the opening. The processing unit is electrically connected to the second sensing units, the fourth motor device and the fifth motor device. When the second sensing units respectively determine that the coins are passed through the opening, the processing unit instructs the fourth motor device and the fifth motor device to operate according to a specific procedure.

In one embodiment of the present disclosure, a coin stacking device is provided, and the coin stacking device includes a main frame, a coin storage portion, a movable stage, a coin organizing device, an elevating device, a rotating device and a coin stirring module. The main frame is formed with an opening. The coin storage portion is connected to the opening, and provided with an axial channel that is in communication with the opening. The movable stage is movably disposed within the axial channel. The coin organizing device is located on the main frame and recessed with a coin collecting recess. The coin collecting recess is connected to the opening and used to receive coins. The coin organizing device is configured to synchronously concentrate the coins in the coin collecting recess onto the movable stage in a radiation manner through the opening, and to organize the coins on the movable stage in a ring shape. The elevating device is connected to the movable stage, and elevatably located on the main frame for elevating the movable stage. The rotating device is connected to the elevating device for rotating the movable stage. The coin stirring module is rotatably located on the coin organizing device, extend into the coin collecting recess for pushing the coins in the coin collecting recess. The coins are able to be stacked successively into a coin tower comprising a plurality of coin-stacking layers through repeated operations of the coin stirring module, the coin organizing device, the elevating device and the rotating device.

In one or more embodiments of the present disclosure, the coin organizing device further includes a stationary plate and a rotatable member. The stationary plate is fixedly mounted on the main frame, and formed with a first annular hole overlapping with the opening. The rotatable member includes an annular frame, a coin template and a second annular hole. The coin template is sandwiched between the stationary plate and the annular frame, and fixedly connected to the annular frame. The second annular hole is located on the annular frame, and collectively forming the coin collecting recess with the coin template for receiving the coins. The coin template is formed with a plurality of coin holes located within the coin collecting recess and surrounding the first annular hole located on the annular frame, and collectively forming a coin collecting recess with the coin template for receiving the coins. A hole diameter of each of the coin holes is merely to accommodate one of the coins, and the coins are guided to directly fall onto the stationary plate by the coin holes so as to jointly surround the first annular hole.

In one or more embodiments of the present disclosure, the coin organizing device further includes a blade layer. The blade layer includes a plurality of blade pieces that are independent to one another. The blade pieces are respectively slidably located between the coin template and the stationary plate, and arranged side by side in sequence to enclose a changeable space that is connected to the axial channel through the first annular hole. The annular frame is able to move the blade pieces synchronously towards the first annular hole through the coin template, such that the blade pieces narrow the changeable space together. When the coin template moves the blade pieces synchronously to narrow the changeable space together, the blade pieces push the coins on the stationary plate from the first annular hole into the axial channel synchronously.

In one or more embodiments of the present disclosure, the rotatable member further includes an arc-shaped rack fixedly located at an outer peripheral surface of the annular frame being opposite to the second annular hole. The coin organizing device includes a first motor device having a rotating shaft, and a first gear member coaxially connected to the rotating shaft of the first motor device to be engaged with the arc-shaped rack. When the first motor device rotates the annular frame through the first gear member, the annular frame synchronously slides the blade pieces through the coin template.

In one or more embodiments of the present disclosure, the coin stacking device further includes a plurality of first sensing units and a processing unit. The first sensing units are arranged on the stationary plate. Each of the first sensing units directed towards one of the coin holes, and is used to sense whether the one of the coin holes is placed with one of the coins. The processing unit is electrically connected to the first sensing units and the first motor device. The first sensing units respectively determine that the coins are placed into all of the coin holes, respectively, the processing unit instructs the first motor device to operate according to notifications of the first sensing units.

In one or more embodiments of the present disclosure, the coin stirring module includes a rotating ring, a plurality of stirring vanes and a second motor device. The rotating ring is rotatably located on the coin organizing device. The stirring vanes are spaced arranged on the rotating ring, respectively extend into the coin collecting recess, and contact the coin template for sweeping the coins in the coin collecting recess to the coin holes. The second motor device is fixedly mounted on the main frame for driving the rotating ring and the stirring vanes to rotate.

In one or more embodiments of the present disclosure, the elevating device includes at least one screw rod, at least one moving spiral tube, a bracket, a rotation-angle sensing unit, a fourth motor device, a gear wheel and a transmission belt. The screw rod is disposed on the main frame, and formed with an external thread portion. The moving spiral tube is elevatably sleeved on the screw rod, and formed with an internal thread portion which is engaged with the external thread portion. The bracket is fixedly connected to the moving spiral tube for loading the movable stage. The rotation-angle sensing unit is coupled to one end of the screw rod for sensing a rotation angle of the screw rod. The fourth motor device is fixedly mounted on the main frame, and provided with a rotating shaft. The gear wheel is coaxially connected to the rotating shaft of the fourth motor device. The transmission belt is engaged with the gear wheel and the at least one screw rod. When the fourth motor device drives the at least one screw rod to rotate in sequence, the at least one moving spiral tube moves the bracket and the movable stage to be relatively elevated in the axial channel.

In one or more embodiments of the present disclosure, the movable stage includes a cylinder and a rack portion. The cylinder is disposed on the bracket of the elevating device for loading the coins. The rack portion is fixedly mounted on an outer peripheral surface of the cylinder. The rotating device includes a fifth motor device and a gear assembly. The fifth motor device is fixedly mounted on the bracket of the elevating device. The gear assembly is coaxially connected to a rotating shaft of the fifth motor device, and engaged with the rack portion for rotating the cylinder. When the fifth motor device drives the cylinder to rotate, the coins are rotated with the cylinder in the axial channel together.

In one or more embodiments of the present disclosure, the coin stacking device further includes two second sensing units and a processing unit. The second sensing units are located relatively in the opening for sensing whether the coins are pushed into the opening. The processing unit is electrically connected to the second sensing units, the fourth motor device and the fifth motor device. When the second sensing units respectively determine that the coins are passed through the opening, the processing unit instructs the fourth motor device and the fifth motor device to operate according to a specific procedure.

Thus, through the construction of the embodiments above, the stacking time that a coin tower is finished to be stacked in the game machine will not be so long, so that the user will be satisfied because the coin towers can be finished in a short period of time.

The above description is merely used for illustrating the problems to be resolved, the technical methods for resolving the problems and their efficacies, etc. The specific details of the present disclosure will be explained in the embodiments below and related drawings.

### BRIEF DESCRIPTION OF THE DRAWINGS

The accompanying drawings are included to provide a further understanding of the present disclosure, and are incorporated in and constitute a part of this specification. The drawings illustrate embodiments of the present disclosure and, together with the description, serve to explain the principles of the present disclosure.

FIG. 1 is a perspective view of a coin stacking device according to one embodiment of the present disclosure.

FIG. 2 is a top view of the coin stacking device of FIG. 1.

FIG. 3 is an exploded view of the coin stacking device of FIG. 1.

FIG. 4 is an exploded view of a coin organizing device of FIG. 3.

FIG. 5A and FIG. 5B are continuous operation views of the coin organizing device of FIG. 3.

FIG. 6 is a cross-sectional view of the coin stacking device viewed along a line A-A of FIG. 3.

FIG. 7A is a bottom view of the coin stacking device of FIG. 1.

FIG. 7B is a side view of the coin stacking device of FIG. 1.

FIG. 8A to FIG. 8D are perspective views of coin towers finished in different embodiments of the present disclosure.

FIG. 9 is an operation flow chart of the coin stacking device according to one embodiment of the present disclosure.

FIG. 10 is an operation view of the coin stacking device according to one embodiment of the present disclosure.

### DESCRIPTION OF THE EMBODIMENTS

Reference will now be made in detail to the present embodiments of the present disclosure, examples of which are illustrated in the accompanying drawings. Wherever possible, the same reference numbers are used in the drawings and the description to refer to the same or like parts. According to the embodiments, it will be apparent to those skilled in the art that various modifications and variations can be made to the structure of the present disclosure without departing from the scope or spirit of the present disclosure.

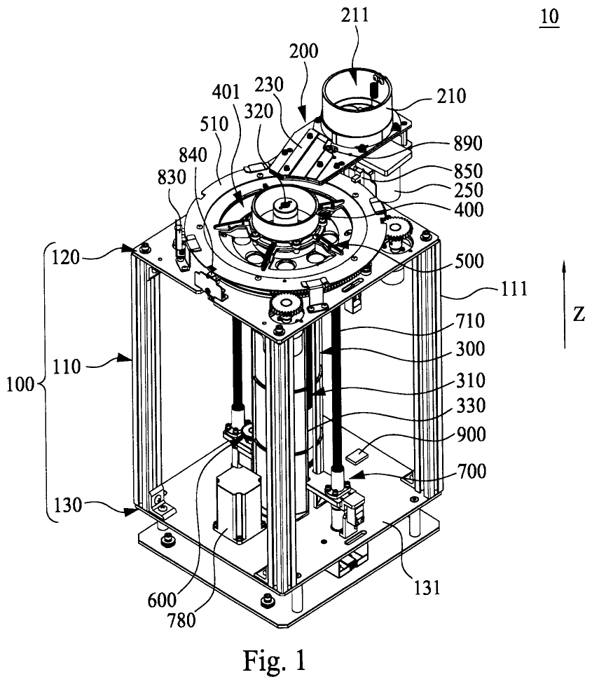

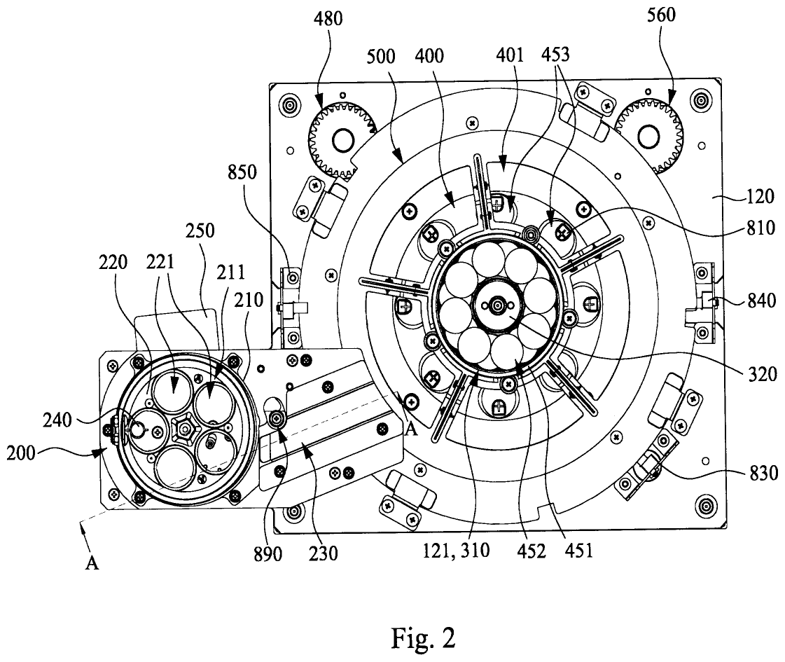

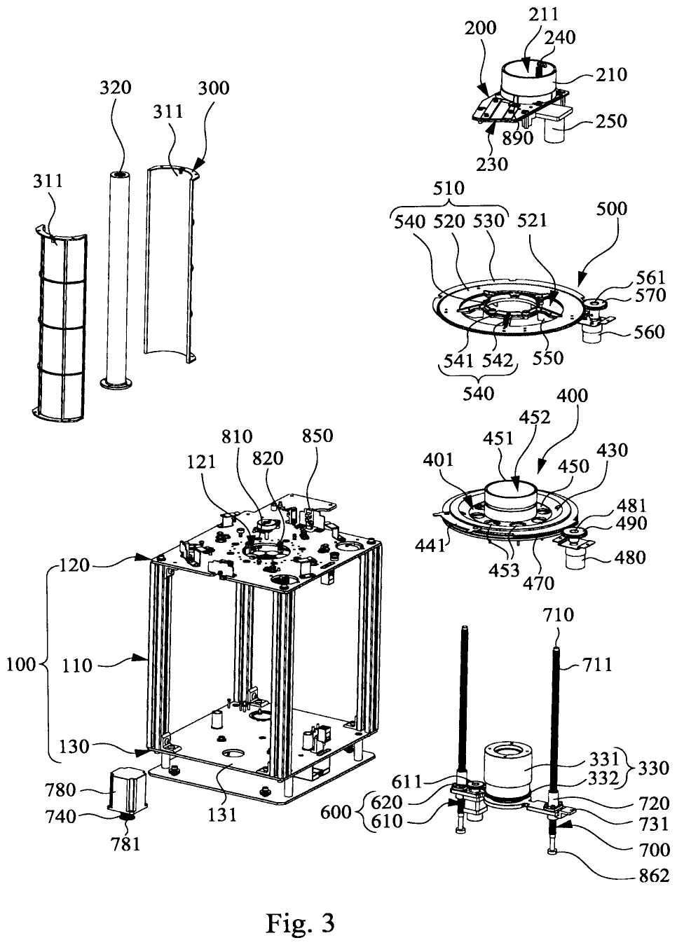

Reference is now made to FIG. 1 to FIG. 3, in which FIG. 1 is a perspective view of a coin stacking device 10 according to one embodiment of the present disclosure, FIG. 2 is a top view of the coin stacking device 10 of FIG. 1, and FIG. 3 is an exploded view of the coin stacking device 10 of FIG. 1. As shown in FIG. 1 to FIG. 3, the coin stacking device 10 includes a main frame 100, a coin feeding module 200, a coin storage portion 300, a middle post 320, a movable stage 330, a coin organizing device 400, a coin stirring module 500, a rotating device 600 and an elevating device 700. The main frame 100 is provided with a frame body 110, a platform 120 and a base 130. The platform 120 and the base 130 are respectively disposed on two opposite ends of the frame body 110, and the platform 120 is formed with an opening 121. In the embodiment, the frame body 110 is formed by a plurality of supporting columns 111 spaced apart from each other. Each of the supporting columns 111 is respectively connected to the platform 120 and the base 130, however, the disclosure is not limited to expressive forms of the frame body 110.

The coin storage portion 300 is disposed in the frame body 110, and connected to the base 130 and the platform 120. More specifically, one end of the coin storage portion 300 is fixedly connected to the platform 120, the other end of the coin storage portion 300 is fixedly connected to the base 130. The end of the coin storage portion 300 is provided with an axial channel 310 that is in communication with the opening 121 of the platform 120, and a long axis direction (e.g., Z axis) of the axial channel 310 is the same as the long axis direction (e.g., Z axis) of the coin storage portion 300. In the embodiment, the coin storage portion 300 includes two arc-shaped parts 311 disposed apart from each other, and the above-mentioned axial channel 310 is defined between the arc-shaped parts 311. However, the disclosure is not limited to expressive forms of the coin storage portion 300.

The movable stage 330 is movably disposed within the axial channel 310. For example, the movable stage 330 is rotatably disposed within the axial channel 310. The elevating device 700 is fixedly connected to the movable stage 330 and the rotating device 600, and elevatably located on the base 130 for jointly carrying the movable stage 330 and the rotating device 600 to ascend or descend a certain distance along the long axis direction (e.g., Z axis) of the axial channel 310. The rotating device 600 is fixedly connected to the elevating device 700 for rotating the movable stage 330 to a certain degree.

The middle post 320 is uprightly disposed in the frame body 110, connected to the base 130 and the platform 120, and located within the axial channel 310. More specifically, one end of the middle post 320 is fixedly connected to a bottom plate 131 of the base 130, the other end of the middle post 320 extend through the elevating device 700, the movable stage 330, the opening 121 and the coin organizing device 400. Thus, the movable stage 330 is able to relatively ascend or descend along the middle post 320 and relatively rotate around the middle post 320. The coin feeding module 200 is used to feed a plurality of coins C. The coin organizing device 400 is located on the platform 120 of the main frame 100, and surrounds the opening 121. The coin organizing device 400 is concavely formed with a coin collecting recess 401. After the coins C are sequentially sent into the coin collecting recess 401 from the coin feeding module 200, the coin organizing device 400 is able to synchronously converge and concentrate the coins C from the coin collecting recess 401 onto the movable stage 330 through the opening 121 in a radiation manner, and organize the coins C in a ring shape on the movable stage 330.

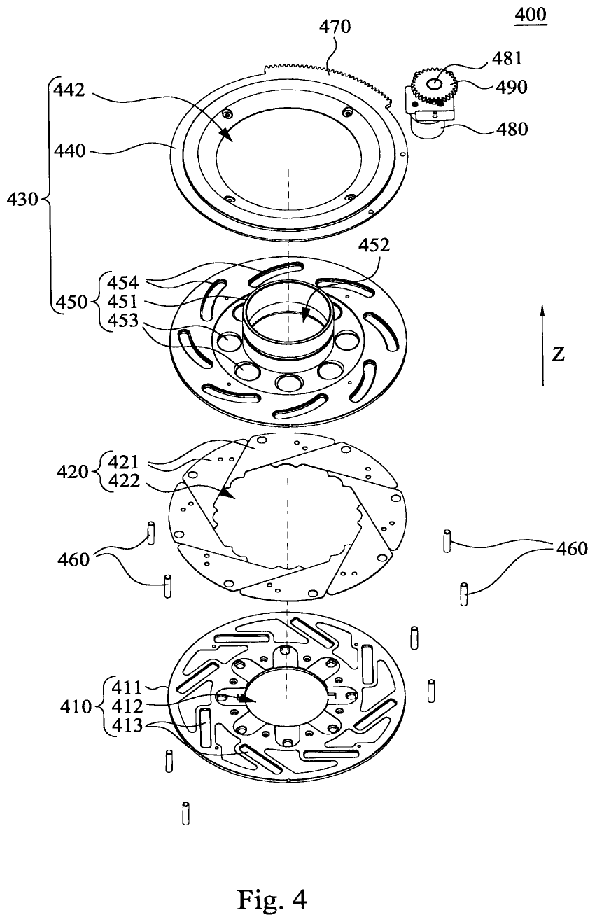

FIG. 4 is an exploded view of a coin organizing device 400 of FIG. 3. As shown in FIG. 3 and FIG. 4, more specifically, in the embodiment, the coin organizing device 400 further includes a stationary plate 410, a blade layer 420, a rotatable member 430 and a plurality of sliding shafts 460. In the embodiment, the stationary plate 410 is fixedly mounted on the platform 120, and provided with an annular sheet 411, a first annular hole 412 and a plurality of narrow grooves 413. The first annular hole 412 is formed in the center of the annular sheet 411 and overlaps with the opening 121, for example, the first annular hole 412 and the opening 121 are coaxial with each other. The narrow grooves 413 are equidistantly formed on the annular sheet 411, and respectively surround the first annular hole 412. A long axis direction of each of the narrow grooves 413 is the tangent of the first annular hole 412.

In the embodiment, the rotatable member 430 includes an annular frame 440, a coin template 450 and a second annular hole 442. The coin template 450 is stacked to be sandwiched between the stationary plate 410 and the annular frame 440, and fixedly connected to the annular frame 440. The second annular hole 442 is located on the annular frame 440, and the aforementioned coin collecting recess 401 is formed by the coin template 450 and the second annular hole 442, collectively. The coin template 450 includes a column portion 451, a plurality of first coin holes 453 and a plurality of arc grooves 454. The column portion 451 is connected to the coin template 450 at a center of the coin template 450, and surrounded by the first coin holes 453.

The column portion 451 is formed with a through passage 452 being in communication with the first annular hole 412. The first coin holes 453 are spaced arranged within the coin collecting recess 401, and surround the first annular hole 412. A hole diameter of each of the first coin holes 453 is merely to accommodate one of the coins C, in other words, the shape of each of the first coin holes 453 is substantially the same as that of each of the coins C, and only a single coin C in a lying position is able to pass through one of the first coin holes 453 at a time.

The arc grooves 454 are equidistantly arranged on the coin template 450, respectively, and surround the first coin holes 453 and the protruding column portion 451. The arc grooves 454 are curved, and respectively extend towards the outer edge of the coin template 450 from the column portion 451, and the curvatures of the arc grooves 454 are the same with each other.

As shown in FIG. 2 and FIG. 3, the coin stacking device 10 mentioned above further includes a plurality of first sensing units 810 and two second sensing units 820. The first sensing units 810 are equiangularly located on the stationary plate 410. Each of the first sensing unit 810 is directed towards one of the first coin holes 453, or is located within the corresponding first coin hole 453 so as to sense whether the corresponding first coin hole is received with one of the coins C. The second sensing units 820 are located relatively on an inner wall of the opening 121 for sensing whether the coins C are pushed into the opening 121. Each of the first sensing units 810 and the second sensing units 820 are not limited to a contact sensing unit or a non-contact sensing unit, respectively. The non-contact sensing unit is, for example, an inductive sensor or a photosensitive sensor and the like. The contact sensing unit is, for example, a tact switch and the like.

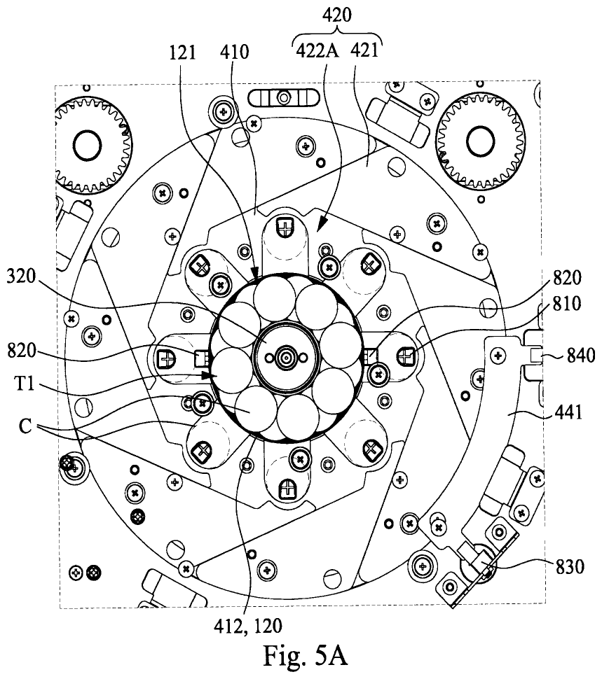

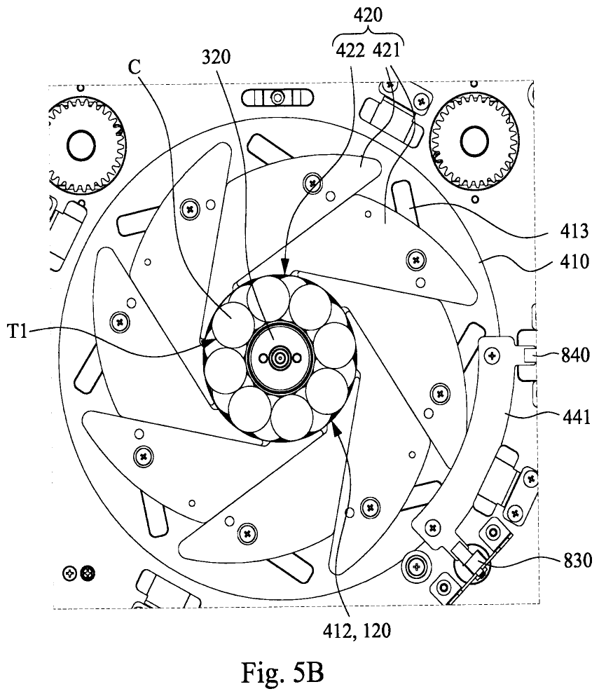

FIG. 5A and FIG. 5B are continuous operation views of the coin organizing device of FIG. 3. As shown in FIG. 4 and FIG. 5A, the blade layer 420 includes a plurality of blade pieces 421 that are independent to one another. The blade pieces 421 are respectively slidably located between the coin template 450 and the stationary plate 410, and arranged side by side in sequence to enclose a changeable space 422A that is connected to the axial channel 310 through the first annular hole 412 (FIG. 5A). The annular frame 440 is able to move the blade pieces 421 synchronously towards the first annular hole 412 through the coin template 450, such that the blade pieces 421 can move together to narrow the changeable space 422A into another changeable space 422B. Each of the sliding shafts 460 only goes through one of the blade pieces 421, and two ends of each of the sliding shafts 460 are respectively slidably disposed within the arc grooves 454 and the narrow grooves 413. The numbers of the arc grooves 454, the blade pieces 421, the narrow grooves 413 and the sliding shafts 460 are the same as each other.

As shown in FIG. 5A and FIG. 5B, when the rotatable member 430 rotates relative to the stationary plate 410, the rotatable member 430 pushes the sliding shafts 460 through the arc grooves 454, respectively, so that the blade pieces 421 respectively move along the corresponding narrow grooves 413, so that the blade pieces 421 synchronously adjust the changeable space 422A. Therefore, when the coin template 450 moves the blade pieces 421 to jointly narrow the changeable space 422A into the changeable space 422B, the blade pieces 421 synchronously push the coins C on the stationary plate 410 into the axial channel 310 from the first annular hole 412. Thus, the coins C are guided to directly fall onto the stationary plate 410 by the first coin holes 453 so as to jointly surround the first annular hole 412 (FIG. 2). In this embodiment, the coin template 450 is circular, however, the disclosure is not limited to expressive forms of the coin template 450.

As shown in FIG. 3 and FIG. 4, the rotatable member 430 further includes an arc-shaped rack 470. The arc-shaped rack 470 is fixedly located at an outer peripheral surface of the annular frame 440 being opposite to the second annular hole 442. The coin organizing device 400 includes a first motor device 480 having a rotating shaft 481, and a first gear member 490 coaxially connected to the rotating shaft 481 of the first motor device 480 to be engaged with the arc-shaped rack 470. When the first motor device 480 rotates the annular frame 440 through the first gear member 490, the annular frame 440 synchronously slides the blade pieces 421 through the coin template 450. The first motor device 480 is, for example, a servo motor, a stepping motor or a common brushless motor, however, the disclosure is not limited to expressive forms of the motor device.

As shown in FIG. 2 and FIG. 5A, the coin organizing device 400 includes a start-point sensing unit 830 and an end-point sensing unit 840. The start-point sensing unit 830 and the end-point sensing unit 840 are spaced fixed on the platform 120, and respectively face towards the annular frame 440. The rotatable member 430 further includes a sensed tab 441 protruding from an outer peripheral surface of the annular frame 440 opposite to the second annular hole 442.

In this way, when the first motor device 480 rotates the annular frame 440 forwardly, such that the blade pieces 421 jointly narrow the changeable space 422A into the changeable space 422B (i.e., the coins C are synchronously pushed into the axial channel 310 towards the first annular hole 412, FIG. 5B), the sensed tab 441 is moved to the start-point sensing unit 830 with the movement of the annular frame 440. Therefore, the sensed tab 441 can be sensed by the start-point sensing unit 830; on the contrary, when the first motor device 480 rotates the annular frame 440 backwardly, so that the blade pieces 421 jointly broaden the changeable space 422B back to the changeable space 422A (i.e., the blade pieces 421 are pushed back to the original position in a direction facing away from the first annular hole 412, FIG. 5A), the sensed tab 441 is moved to the end-point sensing unit 840 with the movement of the annular frame 440. Therefore, the sensed tab 441 can be sensed by the end-point sensing unit 840.

As shown in FIG. 2 and FIG. 3, the coin stirring module 500 includes a rotating ring 510, a plurality of stirring vanes 550 and a second motor device 560 having a rotating shaft 561. The rotating ring 510 is rotatably located on the coin organizing device 400. The stirring vanes 550 are spaced arranged on the rotating ring 510, respectively extend into the coin collecting recess 401, and contact the coin template 450 for pushing the coins C in the coin collecting recess 401 to the first coin holes 453. The second motor device 560 is fixedly mounted on the main frame 100 for driving the rotating ring 510 and the stirring vanes 550 to rotate.

More specifically, in this embodiment, the rotating ring 510 further includes an outer ring body 520, a surrounding rack 530 and an inner annular frame 540. The outer ring body 520 is formed with a third annular hole 521 overlapping with the coin collecting recess 401. The surrounding rack 530 is formed on an outer peripheral surface of the outer ring body 520 opposite to the third annular hole 521. The inner annular frame 540 includes an inner collar 541 and a plurality of support arms 542. The inner collar 541 is located within the third annular hole 521. The support arms 542 are connected to the inner collar 541 and the outer ring body 520, and the support arms 542 are equidistant from each other to surround the inner collar 541. The stirring vanes 550 are respectively connected to the support arms 542 to contact with the coin template 450. The inner collar 541 is rotatably sleeved on the column portion 451, so that the coin stirring module 500 is able to rotate around the column portion 451. The stirring vanes 550 are, for example, soft material sheets (e.g., rubber or plastic material). However, the disclosure is not limited to the expressive forms of the stirring vanes 550. The rotating shaft 561 of the second motor device 560 is coaxially connected to a second gear member 570, and the second gear member 570 is engaged with the surrounding rack 530 for rotating the outer ring body 520 forwardly or reversely.

Thus, when the second motor device 560 rotates the rotating ring 510 through the second gear member 570, the stirring vanes 550 are rotated within the coin collecting recess 401 so as to sweep the coin C not fallen into the first coin hole 453 yet on the coin template 450. The second motor device 560 is, for example, a servo motor, a stepping motor or a common brushless motor, however, the disclosure is not limited to expressive forms of the motor device.

Furthermore, as shown in FIG. 1 and FIG. 3, the coin stirring module 500 further includes a trigger sensing unit 850. The trigger sensing unit 850 is fixedly mounted on the platform 120, and faced towards the rotating ring 510 of the coin stirring module 500. Thus, when the second motor device 560 starts to rotate the rotating ring 510, the trigger sensing unit 850 is able to sense that the rotating ring 510 has already started to rotate.

However, the disclosure is not limited to the coin stirring module 500 being as an essential component of the coin stacking device 10. In other embodiments, the coin stirring module 500 of the disclosure may also be omitted.

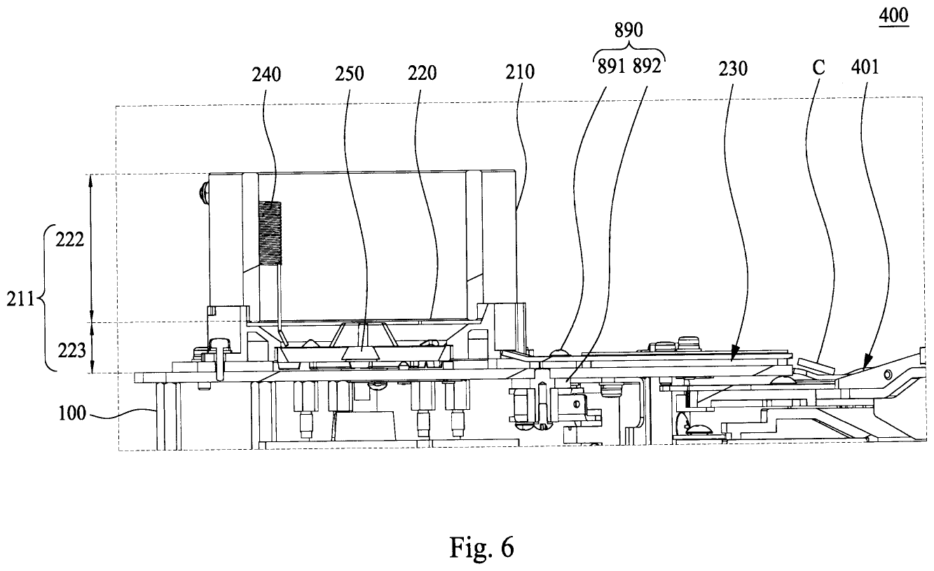

FIG. 6 is a cross-sectional view of the coin stacking device 10 viewed along a line A-A of FIG. 3. As shown in FIG. 2 and FIG. 6, the coin feeding module 200 includes a hopper 210, a coin feeding track 230, a coin-feeding sensing unit 890 and a third motor device 250. The hopper 210 is formed with a material trough 211 for receiving a plurality of coins C. The coin feeding track 230 is fixedly connected to the hopper 210, extended into the material trough 211, and communicated with the material trough 211.

Since the width of the coin feeding track 230 is substantially equal to the diameter of each of the coin C, the coins C in the material trough 211 can be guided to the coin collecting recess 401 sequentially, and fallen into the coin collecting recess 401 thereafter. In other words, the coin feeding track 230 is able to feed one coin C only into the coin collecting recess 401 per time. The third motor device 250 is fixedly mounted on the main frame 100, and connected to the hopper 210 so as to output vibration energy of dropping the coins C into a bottom of the material trough 211, or at least sending the coins C into the coin feeding track 230. The coin-feeding sensing unit 890 is located on the coin feeding track 230 for counting the coins C already moved from the coin feeding track 230 into the coin collecting recess 401. More specifically, the coin-feeding sensing unit 890 includes a rotation wheel 891 and a sensor 892. The rotation wheel 891 is sleeved on the sensor 892, and located at the inner side wall of the coin feeding track 230. The sensor 892 is able to count the rotation times that the coins C sequentially pass to rotate the rotation wheel 891 in the coin feeding track 230, so as to obtain the number of the coins moved into the coin collecting recess 401.

More specifically, the coin feeding module 200 includes a supply template 220 and a spring element 240. The spring element 240 is connected to the hopper 210 and the supply template 220. The supply template 220 is located within the material trough 211 to divide the material trough 211 into an upper space 222 and a lower space 223. The lower space 223 is in communication with the coin feeding track 230. The third motor device 250 is connected to the main frame 100. A rotating shaft 251 of the third motor device 250 extends into the lower space 223, and is pivotally connected to the supply template 220 for rotating the supply template 220 in the material trough 211. The supply template 220 is formed with a plurality of second coin holes 221 (as shown in FIG. 2). The second coin holes 221 are arranged on the supply template 220 to be communicated with the upper space 222 and the lower space 223. A hole diameter of each of the second coin holes 221 is merely to accommodate one of the coins C, in other words, the shape of each of the second coin holes 221 is substantially the same as that of each of the coins C, and only a single coin C in a lying position is able to pass through one of the second coin holes 221 at a time.

Therefore, through the repeated operations of rotating the supply template 220 to pull the spring element 240 by the third motor device 250 and stopping the rotation of the third motor device 250 to restore the spring element 240, the coin feeding module 200 outputs vibration energy of dropping the coins C into a bottom of the material trough 211 from the second coin holes 221, or at least sending the coins C into the coin feeding track 230. The third motor device 250 is, for example, a servo motor, a stepping motor or a common brushless motor, however, the disclosure is not limited to expressive forms of the motor device.

However, the disclosure is not limited to the hopper 210 of the coin feeding module 200 as an essential component of the coin stacking device 10. In other embodiments, the hopper 210 of the disclosure may also be omitted.

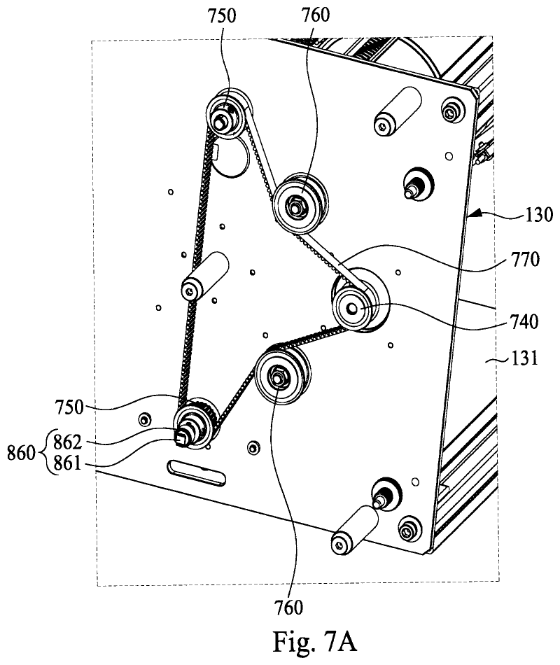

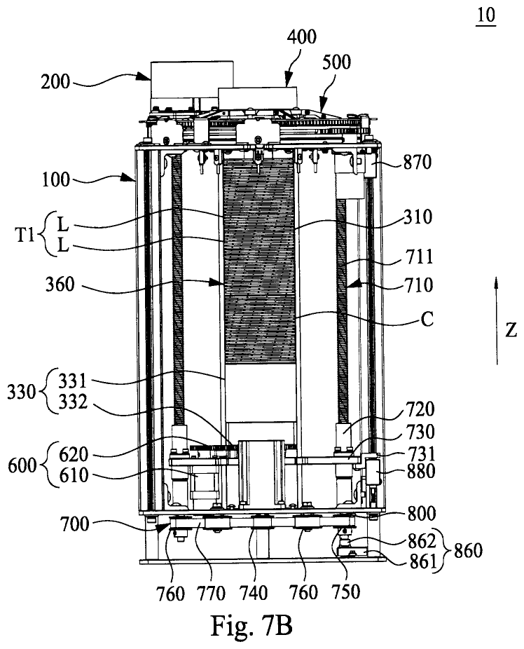

FIG. 7A is a bottom view of the coin stacking device 10 of FIG. 1, and FIG. 7B is a side view of the coin stacking device 10 of FIG. 1. As shown in FIG. 7A and FIG. 7B, the elevating device 700 includes two screw rods 710, two moving spiral tubes 720, a bracket 730, a fourth motor device 780, a first gear wheel 740, two second gear wheels 750 and a transmission belt 770. The screw rods 710 are spaced arranged on the main frame 100. Each of the screw rods 710 is pivotally connected to the base 130 and the platform 120. More specifically, both of the screw rods 710 are located on one surface of the bottom plate 131 facing towards the platform 120. One end of each of the screw rods 710 passes through the bottom plate 131 of the base 130, and is coaxially connected to one of the second gear wheels 750, so that the second gear wheels 750 can be rotatable with the screw rods 710. Each of the moving spiral tube 720 is elevatably sleeved on one of the screw rods 710. More specifically, each of the screw rods 710 is formed with an external thread portion 711, and each of the moving spiral tubes 720 is formed with an internal thread portion (not shown in figures). The bracket 730 passes through the axial channel 310, and is fixedly connected to the moving spiral tubes 720 for carrying the movable stage 330. The fourth motor device 780 is fixedly mounted on one surface of the bottom plate 131 facing towards the platform 120. The first gear wheel 740, the second gear wheel 750 and the transmission belt 770 are all located on one surface of the bottom plate 131 opposite to the platform 120. A rotating shaft 781 of the fourth motor device 780 passes through the bottom plate 131, and is coaxially connected to the first gear wheel 740. The transmission belt 770 is engaged with the first gear wheel 740, the second gear wheel 750 and two guiding wheels 760.

Therefore, when the fourth motor device 780 respectively rotates the screw rods 710 through the transmission belt 770, through the internal thread portion being engaged with the external thread portion 711, the moving spiral tubes 720 start to ascend or descend relatively along the long axis direction of the axial channel 310, thereby ascending or descending the bracket 730 and the movable stage 330. The fourth motor device 780 is, for example, a servo motor, a stepping motor or a common brushless motor. However, the disclosure is not limited to the expressive forms of the motor device.

Furthermore, the elevating device 700 further includes a rotation-angle sensing unit 860. The rotation-angle sensing unit 860 is fixedly mounted on the base 130, and coupled to one of the screw rods 710 for sensing a rotation angle of the screw rod 710. Thus, when the fourth motor device 780 starts to rotate the screw rods 710 together, the rotation-angle sensing unit 860 can instantly sense the rotation angle of the screw rod 710 so as to sense the current lifting volume of the bracket 730. More specifically, the rotation-angle sensing unit 860 includes a Hall sensing module 861 and a magnet element 862. The Hall sensing module 861 is fixedly mounted on the base 130 of the main frame 100. The magnet element 862 is fixedly mounted to one distal end of the screw rods 710, and is coaxially aligned with the Hall sensing module 861. Therefore, when the magnet element 862 rotates with the corresponding screw rod 710, the Hall sensing module 861 can sense the magnetic field change of the magnet element 862, thereby obtaining the rotation angle of the screw rod 710 to acquire the current lifting volume of the bracket 730. However, the disclosure is not limited to the expressive forms of the rotation-angle sensing unit 860.

In addition, the elevating device 700 includes a sensed rib 731, a high position sensing unit 870 and a low position sensing unit 880. The sensed rib 731 is fixedly mounted on the bracket 730 and liftable together with the bracket 730. The high position sensing unit 870 and the low position sensing unit 880 are oppositely disposed on the main frame 100, that is, the high position sensing unit 870 is fixed to the platform 120, and the low position sensing unit 880 is fixed to a bottom plate 131 of the base 130, and both of the high position sensing unit 870 and the low position sensing unit 880 are aligned with each other. The high position sensing unit 870 and the low position sensing unit 880, are example photo interrupter. However, the disclosure is not limited to the expressive forms of the sensing units.

Thus, when the sensed rib 731 is ascended to the high position sensing unit 870 with the bracket 730, the high position sensing unit 870 is able to sense the sensed rib 731 so as to output a signal that the bracket 730 has been reached the high position of the main frame 100. On the contrary, when the sensed rib 731 is descended to the low position sensing unit 880 with the bracket 730, the low position sensing unit 880 is able to sense the sensed rib 731 so as to output a signal that the bracket 730 has been reached the low position of the main frame 100.

As shown FIG. 3 and FIG. 7B, the movable stage 330 includes a cylinder 331 and a rack portion 332. The cylinder 331 is disposed on the bracket 730 of the elevating device 700 for loading the coins C. The rack portion 332 is fixedly mounted on an outer peripheral surface of the cylinder 331. The rotating device 600 includes a fifth motor device 610 and a gear assembly 620. The fifth motor device 610 is fixedly mounted on the bracket 730 of the elevating device 700. The gear assembly 620 is coaxially connected to a rotating shaft 611 of the fifth motor device 610, and engaged with the rack portion 332 for rotating the cylinder 331. Thus, when the fifth motor device 610 drives the cylinder 331 to rotate, the coins C are rotated with the cylinder 331 in the axial channel 310 together.

Thus, through the repeated operations of the coin organizing device 400 collecting the coins C, the elevating device 700 descending and the rotating device 600 rotating, the coins C are able to be upwardly stacked successively into a coin tower T1 having a plurality of coin-stacking layers L. The coin-stacking layers L of the coin tower T1 surround the middle post 320 in the axial channel 310 (FIG. 2 and FIG. 7B).

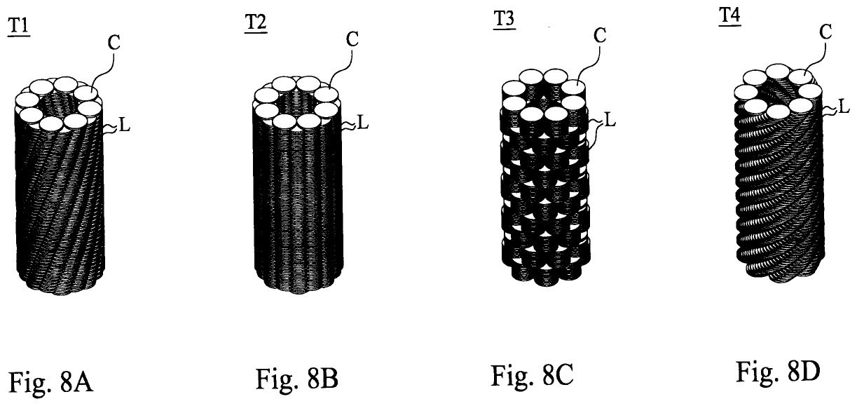

FIG. 8A to FIG. 8D are perspective views of coin towers T1˜T4 finished in different embodiments of the present disclosure. As shown in FIG. 3 and FIG. 7B, after the coins C are concentrated onto the movable stage 330 by the coin organizing device 400, through the collocation of different parameters of the elevating device 700 and the rotating device 600, the coins C can be stacked successively into one of coin towers T1-T4 which are different in shapes (FIG. 8A to FIG. 8D).

It is noted, in this specification, the term “coin” mentioned above is significant broadly, not only includes coins as currency, but also the similar object of coin such as chips and tokens, wherein the shape of “coin” is not limited to round, other embodiment, and the shape of “coin” can be polygonal or any other shape.

Also, as shown in FIG. 1 and FIG. 7B, the above-mentioned coin stacking device 10 further includes a processing unit 900. The processing unit 900 is electrically connected to the first sensing unit 810, the second sensing units 820, the start-point sensing unit 830, the end-point sensing unit 840, the trigger sensing unit 850, the rotation-angle sensing unit 860, the high position sensing unit 870, the low position sensing unit 880, the coin-feeding sensing unit 890, the first motor device 480, the second motor device 560, the third motor device 250, the fourth motor device 780 and the fifth motor device 610 (FIG. 3).

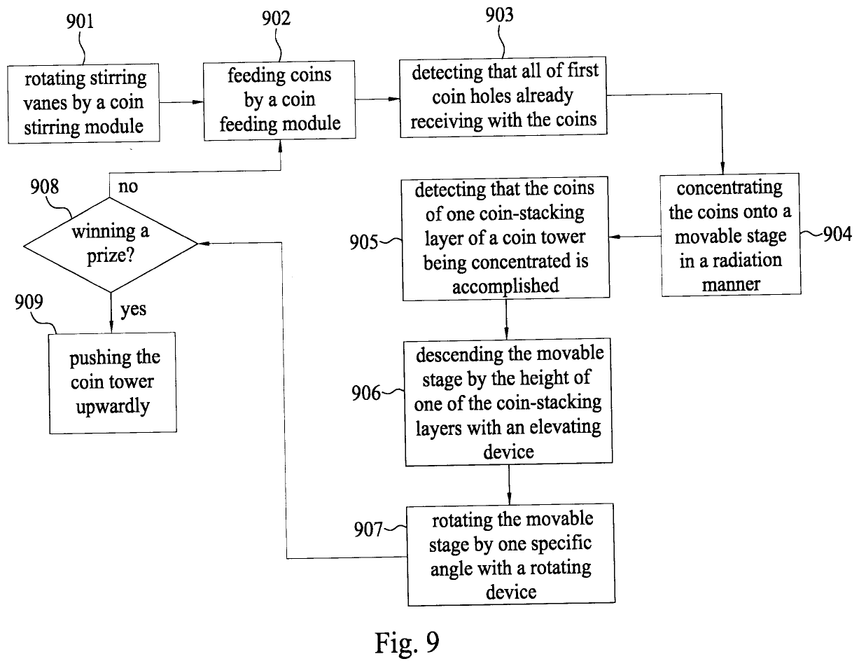

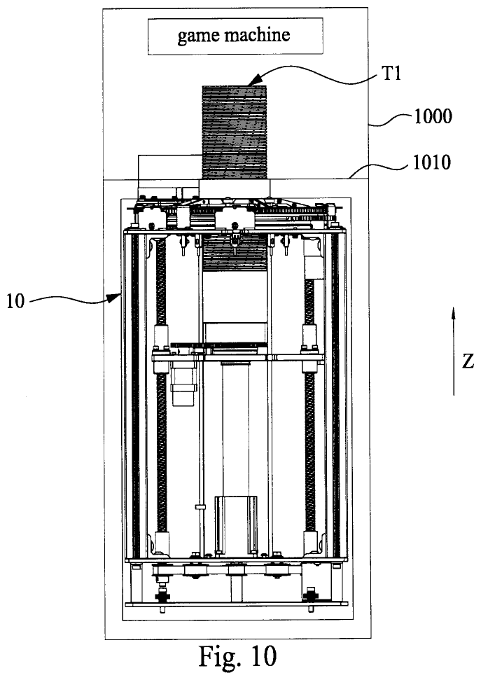

Reference is now made to FIG. 9 and FIG. 10, in which FIG. 9 is an operation flow chart of the coin stacking device 10 according to one embodiment of the present disclosure, and FIG. 10 is an operation view of the coin stacking device 10 according to one embodiment of the present disclosure. As shown in FIG. 1, FIG. 9 and FIG. 10, in this embodiment, when the coin stacking device 10 is used in the gaming machine field, and the coin stacking device 10 is placed under a partition plate 1010 of the gaming machine 1000. The processing unit 900 performs the stacking task according to the following step 901-step 909. In step 901, the coin stirring module 500 is activated to rotate the stirring vanes 550. In step 902, the processing unit 900 activates the coin feeding module 200 to feed coins C to the coin collecting recess 401. In step 903, the processing unit 900 detects that all of the first coin holes 453 are received with one of the coins C. In step 904, the processing unit 900 activates the coin organizing device 400 to synchronously concentrate the coins C onto the movable stage 330 in a radiation manner. In step 905, the processing unit 900 detects that the coins C of a specific coin-stacking layer L of the coin tower being concentrated onto the movable stage 330 is accomplished. In step 906, the processing unit 900 activates the elevating device 700 to lower the movable stage 330 by the height of one of the coin-stacking layers L. In step 907, the processing unit 900 activates the rotating device 600 to rotate the movable stage 330 by a specific angle. In step 908, the processing unit 900 determines whether a user win a prize, if yes, go to step 909, otherwise, go back to step 902. In step 909, the processing unit 900 activates the elevating device 700 to ascend the coin tower T1 from the axial channel 310 to be above the partition plate 1010.

More particularly, in step 901, the second motor device 560 is activated to rotate the rotating ring 510 and the stirring vanes 550. The stirring vanes 550 are rotated within the coin collecting recess 401 so as to sweep the coin C not fallen into the first coin hole 453 yet on the coin template 450. In step 902, since the trigger sensing unit 850 senses that the rotating ring 510 has started to rotate, the processing unit 900 activates the third motor device 250 of the coin feeding module 200 accordingly, so that the coins C fall into the coin collecting recess 401 one by one. More specifically, according to a specific procedure, the processing unit 900 sends a certain amount of replenishment coins into the coin collecting recess 401 by the coin feeding module 200 according to the amount of coins sensed by the coin-feeding sensing unit 890. In step 903, the processing unit 900 determines whether all of the first sensing units 810 have detected that the first coin holes 453 are totally received with the coins C. In step 904, when the processing unit 900 confirms that the first coin holes 453 are totally received with the coins C, the processing unit 900 instructs the first motor device 480 to synchronously push the coins C by the blade pieces 421 according to notifications of the first sensing units 810. In step 905, when the processing unit 900 confirms that the coins C have been pushed into the axial channel 310 synchronously according to the feedback from the start-point sensing unit 830 and the end-point sensing unit 840, and the coins C have been passed through the opening 121 according to the feedback from the second sensing units 820, the processing unit 900 continues to proceed step 906 and step 907, that is, the processing unit 900 instructs the fourth motor device 780 and the fifth motor device 610 to operate in sequence according to a specific program.

In step 906, the processing unit 900 instructs the fourth motor device 780 to descend a height of one of the coin-stacking layers L according to the above notification. In addition, the processing unit 900 determines whether the current descent volume is appropriate according to the sensing of the rotation-angle sensing unit 860 described above. In step 907, after the descending of the height of the corresponding coin-stacking layer L is completed, the processing unit 900 then instructs the fifth motor device 610 to rotate the movable stage 330 by a specific angle. In step 908, the processing unit 900 determines whether the winning time of the gaming machine 1000 has achieved according to a specific program. In step 909, when the processing unit 900 determines that the winning time of the gaming machine 1000 has been achieved, the processing unit 900 instructs the fourth motor device 780 to operate according to a specific program, so that the coin tower T1 is lifted upwardly from the opening 121 (FIG. 10). At this moment, the processing unit 900 further can sense the layer number of the coin-stacking layers L of the coin tower T1 being ascended outwards from the opening 121 according to the second sensing units 820. Therefore, when the second sensing units 820 sense that the specific layer number of the coin tower T1 being ascended outwards from the opening 121 is achieved, the processing unit 900 instructs the elevating device 700 to stop operation.

It is noted, the processing unit 900 described in this embodiment is a hardware such as a central control unit or a central processing unit. However, the disclosure is not limited to this. In other embodiments, the processing unit 900 may also be software or firmware.

In this way, the elevating device 700 lifts the coin tower T1 out of the opening 121 upwardly along Z axis from the bottom of the partition plate 1010 of the gaming machine 1000, so as to be exposed above the partition plate 1010 of the gaming machine 1000 for rewarding the user.

Thus, through the construction of the embodiments above, the stacking time that a coin tower is finished to be stacked in the game machine will not be so long, so that the user will be satisfied because the coin towers can be finished in a short period of time.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A coin stacking device, comprising:
a main frame that is formed with an opening;
a coin feeding module that is used to feed a plurality of coins;
a coin storage portion that is connected to the opening, and provided with an axial channel that is in communication with the opening;
a movable stage that is movably disposed within the axial channel;
a coin organizing device that is located on the main frame to surround the opening, and configured to synchronously concentrate the coins from the coin feeding module onto the movable stage in a radiation manner through the opening, and organize the coins on the movable stage in a ring shape;
an elevating device that is connected to the movable stage, and elevatably located on the main frame for elevating the movable stage; and
a rotating device that is connected to the elevating device for rotating the movable stage,
wherein the coins are able to be stacked successively into a coin tower comprising a plurality of coin-stacking layers through repeated operations of the coin organizing device, the elevating device and the rotating device.

2. The coin stacking device of claim 1, wherein the coin organizing device further comprises:
a stationary plate that is fixedly mounted on the main frame, and formed with a first annular hole overlapping with the opening; and
a rotatable member comprising an annular frame, a coin template sandwiched between the stationary plate and the annular frame, and fixedly connected to the annular frame, and a second annular hole located on the annular frame, and collectively forming a coin collecting recess with the coin template for receiving the coins, the coin template that is formed with a plurality of coin holes located within the coin collecting recess and surrounding the first annular hole,
wherein a hole diameter of each of the coin holes is merely to accommodate one of the coins, and the coins are guided to directly fall onto the stationary plate by the coin holes so as to jointly surround the first annular hole.

3. The coin stacking device of claim 2, wherein the coin organizing device further comprises:
a blade layer comprising a plurality of blade pieces being independent to one another, the blade pieces that are respectively slidably located between the coin template and the stationary plate, and arranged side by side in sequence to enclose a changeable space that is connected to the axial channel through the first annular hole, wherein the annular frame is able to move the blade pieces synchronously towards the first annular hole through the coin template, such that the blade pieces narrow the changeable space together,
when the coin template moves the blade pieces synchronously to narrow the changeable space together, the blade pieces push the coins on the stationary plate from the first annular hole into the axial channel synchronously.

4. The coin stacking device of claim 3, wherein the rotatable member further comprises an arc-shaped rack fixedly located at an outer peripheral surface of the annular frame being opposite to the second annular hole; and
the coin organizing device comprises a first motor device having a rotating shaft, and a first gear member coaxially connected to the rotating shaft of the first motor device to be engaged with the arc-shaped rack,
wherein when the first motor device rotates the annular frame through the first gear member, the annular frame synchronously slides the blade pieces through the coin template.

5. The coin stacking device of claim 4, further comprising:
a plurality of first sensing units that are arranged on the stationary plate, and each of the first sensing units that is directed towards one of the coin holes and used to sense whether the one of the coin holes is placed with one of the coins; and
a processing unit that is electrically connected to the first sensing units and the first motor device,
when the first sensing units respectively determine that the coins are placed into all of the coin holes, respectively, the processing unit instructs the first motor device to operate according to notifications of the first sensing units.

6. The coin stacking device of claim 2, further comprising:
a coin stirring module comprising:
a rotating ring that is rotatably located on the coin organizing device;
a plurality of stirring vanes that are spaced arranged on the rotating ring, respectively extending into the coin collecting recess, and contacting the coin template for sweeping the coins in the coin collecting recess to the coin holes; and
a second motor device that is fixedly mounted on the main frame for driving the rotating ring and the stirring vanes to rotate.

7. The coin stacking device of claim 2, wherein the coin feeding module comprises:
a coin feeding track that is fixedly mounted on the main frame for guiding the coins into the coin collecting recess sequentially;
a coin-feeding sensing unit that is located on the coin feeding track for counting the coins already moved from the coin feeding track into the coin collecting recess; and
a third motor device that is connected to the main frame so as to output vibrations for sending the coins into the coin feed track.

8. The coin stacking device of claim 1, wherein the elevating device comprises:
at least one screw rod that is disposed on the main frame, and formed with an external thread portion;
at least one moving spiral tube that is elevatably sleeved on the at least one screw rod, and formed with an internal thread portion which is engaged with the external thread portion;
a bracket that is fixedly connected to the at least one moving spiral tube for loading the movable stage;
a rotation-angle sensing unit that is coupled to one end of the at least one screw rod for sensing a rotation angle of the at least one screw rod;
a fourth motor device that is fixedly mounted on the main frame, and provided with a rotating shaft;
a gear wheel that is coaxially connected to the rotating shaft of the fourth motor device; and
a transmission belt that is engaged with the gear wheel and the at least one screw rod,
wherein when the fourth motor device drives the at least one screw rod to rotate in sequence, the at least one moving spiral tube moves the bracket and the movable stage to be relatively elevated in the axial channel.

9. The coin stacking device of claim 8, wherein the movable stage comprises:
a cylinder that is disposed on the bracket of the elevating device for loading the coins; and
a rack portion that is fixedly mounted on an outer peripheral surface of the cylinder; and
the rotating device comprises:
a fifth motor device that is fixedly mounted on the bracket of the elevating device; and
a gear assembly that is coaxially connected to a rotating shaft of the fifth motor device, and engaged with the rack portion for rotating the cylinder,
wherein when the fifth motor device drives the cylinder to rotate, the coins are rotated with the cylinder in the axial channel together.

10. The coin stacking device of claim 9, further comprising:
two second sensing units that are located relatively in the opening for sensing whether the coins are pushed into the opening; and
a processing unit that is electrically connected to the two second sensing units, the fourth motor device and the fifth motor device,
wherein when the second sensing units respectively determine that the coins are passed through the opening, the processing unit instructs the fourth motor device and the fifth motor device to operate according to a specific procedure.

11. A coin stacking device, comprising:
a main frame that is formed with an opening;
a coin storage portion that is connected to the opening, and provided with an axial channel that is in communication with the opening;
a movable stage that is movably disposed within the axial channel;
a coin organizing device that is located on the main frame and recessed with a coin collecting recess, the coin collecting recess that is connected to the opening and used to receive coins, wherein the coin organizing device is configured to synchronously concentrate the coins in the coin collecting recess onto the movable stage in a radiation manner through the opening, and to organize the coins onto the movable stage in a ring shape;
an elevating device that is connected to the movable stage, and elevatably located on the main frame for elevating the movable stage;
a rotating device that is connected to the elevating device for rotating the movable stage; and
a coin stirring module that is rotatably located on the coin organizing device, extending into the coin collecting recess for pushing the coins in the coin collecting recess,
wherein the coins are able to be stacked successively into a coin tower comprising a plurality of coin-stacking layers through repeated operations of the coin stirring module, the coin organizing device, the elevating device and the rotating device.

12. The coin stacking device of claim 11, wherein the coin organizing device further comprises:
a stationary plate fixedly mounted on the main frame, and formed with a first annular hole overlapping with the opening; and
a rotatable member comprising an annular frame, a coin template sandwiched between the stationary plate and the annular frame, and fixedly connected to the annular frame, and a second annular hole located on the annular frame, and collectively forming the coin collecting recess with the coin template for receiving the coins, the coin template formed with a plurality of coin holes located within the coin collecting recess and surrounding the first annular hole,
wherein a hole diameter of each of the coin holes is merely to accommodate one of the coins, and the coins are guided to directly fall onto the stationary plate by the coin holes so as to jointly surround the first annular hole.

13. The coin stacking device of claim 12, wherein the coin organizing device further comprises:
a blade layer comprising a plurality of blade pieces being independent to one another, the blade pieces that are respectively slidably located between the coin template and the stationary plate, and arranged side by side in sequence to enclose a changeable space that is connected to the axial channel through the first annular hole, wherein the annular frame is able to move the blade pieces synchronously towards the first annular hole through the coin template, such that the blade pieces narrow the changeable space together,
when the coin template moves the blade pieces synchronously to narrow the changeable space together, the blade pieces push the coins on the stationary plate from the first annular hole into the axial channel synchronously.

14. The coin stacking device of claim 13, wherein the rotatable member further comprises an arc-shaped rack fixedly located at an outer peripheral surface of the annular frame being opposite to the second annular hole; and
the coin organizing device comprises a first motor device having a rotating shaft, and a first gear member coaxially connected to the rotating shaft of the first motor device to be engaged with the arc-shaped rack,
wherein when the first motor device rotates the annular frame through the first gear member, the annular frame synchronously slides the blade pieces through the coin template.

15. The coin stacking device of claim 14, further comprising:
a plurality of first sensing units arranged on the stationary plate, and each of the first sensing units directed towards one of the coin holes and used to sense whether the one of the coin holes is placed with one of the coins; and
a processing unit electrically connected to the first sensing units and the first motor device,
when the first sensing units respectively determine that the coins are placed into all of the coin holes, respectively, the processing unit instructs the first motor device to operate according to notifications of the first sensing units.

16. The coin stacking device of claim 12, wherein the coin stirring module comprising:
a rotating ring rotatably located on the coin organizing device;
a plurality of stirring vanes spaced arranged on the rotating ring, respectively extending into the coin collecting recess, and contacting the coin template for sweeping the coins in the coin collecting recess to the coin holes; and
a second motor device fixedly mounted on the main frame for driving the rotating ring and the stirring vanes to rotate.

17. The coin stacking device of claim 11, wherein the elevating device comprises:
at least one screw rod disposed on the main frame, and formed with an external thread portion;
at least one moving spiral tube elevatably sleeved on the at least one screw rod, and formed with an internal thread portion which is engaged with the external thread portion;
a bracket fixedly connected to the at least one moving spiral tube for loading the movable stage;
a rotation-angle sensing unit coupled to one end of the at least one screw rod for sensing a rotation angle of the at least one screw rod;
a fourth motor device fixedly mounted on the main frame, and provided with a rotating shaft;
a gear wheel coaxially connected to the rotating shaft of the fourth motor device; and
a transmission belt engaged with the gear wheel and the at least one screw rod,
wherein when the fourth motor device drives the at least one screw rod to rotate in sequence, the at least one moving spiral tube moves the bracket and the movable stage to be relatively elevated in the axial channel.

18. The coin stacking device of claim 17, wherein the movable stage comprises:
a cylinder disposed on the bracket of the elevating device for loading the coins; and
a rack portion fixedly mounted on an outer peripheral surface of the cylinder; and
the rotating device comprises:
a fifth motor device fixedly mounted on the bracket of the elevating device; and
a gear assembly coaxially connected to a rotating shaft of the fifth motor device, and engaged with the rack portion for rotating the cylinder,
wherein when the fifth motor device drives the cylinder to rotate, the coins are rotated with the cylinder in the axial channel together.

19. The coin stacking device of claim 18, further comprising:
two second sensing units located relatively in the opening for sensing whether the coins are pushed into the opening; and
a processing unit electrically connected to the two second sensing units, the fourth motor device and the fifth motor device,
wherein when the second sensing units respectively determine that the coins are passed through the opening, the processing unit instructs the fourth motor device and the fifth motor device to operate according to a specific procedure.
